(19) United States
(12) Patent Application Publication
(10) Pub. No.: US 2024/0402431 A1
(43) Pub. Date: Dec. 5, 2024

(54) OPTICAL MODULE AND TRANSMISSION APPARATUS

(71) Applicant: Enplas Corporation, Saitama (JP)

(72) Inventor: Takahiro IWASAKI, Saitama (JP)

(73) Assignee: Enplas Corporation, Saitama (JP)

(21) Appl. No.: 18/670,830

(22) Filed: May 22, 2024

(30) Foreign Application Priority Data
May 30, 2023 (JP) 2023-088581

(51) Int. Cl. G02B 6/32; G02B 19/00

(52) U.S. Cl. CPC G02B 6/322; G02B 6/325; G02B 19/0014; G02B 19/0028; G02B 19/0052

(57) ABSTRACT

The optical receptacle includes an incidence surface and an emission surface. Light emitted from the light-emitting element includes a first light beam and a second light beam. A first light flux of the first light beam that is emitted at ±10 degrees with respect to the optical axis is focused on the central light beam of the first light flux after it is emitted from the emission surface. A second light flux of the second light beam that is emitted from an emission point at ±10 degrees with respect to the optical axis is controlled to be located on the opposite side of the emission point side with respect to the central light beam of the first light flux after it is emitted from the emission surface, the emission point being an end portion of one light-emitting surface on the plane.

This application claims the benefit of priority of Japanese Patent Application No. 2023-088581, filed on May 30, 2023, the disclosure of which including the specification, drawings and abstract is incorporated herein by reference in its entirety.

### TECHNICAL FIELD

The present invention relates to an optical module and a transmission apparatus.

### BACKGROUND ART

In the related art, optical modules including light-emitting elements such as surface-emitting lasers (such as vertical-cavity surface-emitting lasers (VCSEL) are used for optical communications using optical transmission members such as optical fibers and light waveguides. The optical module includes a light-emitting element and an optical receptacle. Some optical receptacles have a function of a meniscus lens for the purpose of reducing the spherical aberration (see, for example, PTL 1).

PTL 1 discloses an optical module device (optical module) for transmitting optical signals through an optical fiber. The optical module device includes a light-emitting element, an optical fiber, an optical bench, and a cover. The cover includes a lens assembly for controlling the distribution of light emitted from the light-emitting element. The lens assembly includes an incidence surface that is a convex lens surface and an emission surface that is a concave lens surface. Light emitted from the light-emitting element enters from the incidence surface that is a convex lens, and is emitted from the emission surface that is a concave lens surface, thus being focused at the end surface of the optical fiber.

### CITATION LIST

### Patent Literature

PTL 1

Japanese Unexamined Patent Application Publication (Translation of PCT Application) No. 2019-526838

### SUMMARY OF INVENTION

### Technical Problem

With the optical module device disclosed in PTL 1, however, the light coupling efficiency of light emitted from the light-emitting element to the optical fiber may be reduced depending on the assembly accuracy of the cover (lens assembly) and the optical fiber. The reduction in light coupling efficiency occurs when the positions of the cover and the optical fiber are shifted in the front-rear direction along the axis of the optical fiber, the left-right direction perpendicular to the front-rear direction, and/or the up-down direction perpendicular to the front-rear direction and left-right direction.

In view of this, an object of the present invention is to provide an optical module and a transmission apparatus with which the light coupling efficiency is less reduced even when the positions of an optical receptacle and an optical transmission member are shifted in any direction.

### Solution to Problem

[1] An optical module including: a light-emitting element disposed on a substrate; and an optical receptacle configured to optically couple the light-emitting element and an end surface of an optical transmission member when the optical transmission member is connected, in which the optical receptacle includes: an incidence surface that is a convex surface configured to allow incidence of light emitted from the light-emitting element, and an emission surface that is a concave surface configured to emit to the end surface of the optical transmission member light entered from the incidence surface, in which light emitted from the light-emitting element toward the end surface of the optical transmission member includes a first light beam emitted from a center of a light-emitting surface of the light-emitting element, and a second light beam emitted from an outer edge of the light-emitting surface, in which a first light flux of the first light beam is focused on a light path of a central light beam of the first light flux after the first light flux is emitted from the emission surface, the first light flux being a light flux that is emitted at ±10 degrees with respect to an optical axis, and in which in a plane that includes a light path of the central light beam of the first light flux and is perpendicular to the substrate, a second light flux of the second light beam is controlled to be located on an opposite side of a side on which the emission point is located with respect to the light path of the central light beam of the first light flux after the second light flux is emitted from the emission surface, the second light flux being a light flux that is emitted at ±10 degrees with respect to the optical axis from one of two emission points that are the outer edge of the light-emitting surface on the plane.
[2] The optical module according to [1], in which when a virtual column with a radius of 3 μm and a length of 30 μm is disposed such that a central axis of the virtual column is parallel to the optical transmission member and that a center of gravity of the virtual column is located on the light path of the central light beam of the first light flux at a position where the first light flux is thinnest, in a plane including the light path of the central light beam of the first light flux and the emission point, the second light flux is controlled to be located inside the virtual column and on the opposite side of the side on which the emission point is located with respect to the light path of the central light beam of the first light flux after the second light flux is emitted from the emission surface.
[3] The optical module according to [2], in which a center of an end surface of a core of the optical transmission member is disposed inside the virtual column.
[4] The optical module according to [1], in which the position where the first light flux is thinnest and a position where the second light flux is thinnest are different from each other.
[5] The optical module according to [1], in which the following Equation 1 is satisfied:

$$R 1 > R 2 \qquad ( Equation 1 )$$

where R1 is a curvature radius of a center of the incidence surface, and R2 is a curvature radius of a center of the emission surface.
[6] The optical module according to [1], in which the following Equation 2 is satisfied:

$$E 1 / E 2 > 7 \qquad ( Equation 2 )$$

where E1 is a diameter on the incidence surface of light emitted from the light-emitting element that impinges on the incidence surface, and E2 is a diameter on the emission surface of light emitted from the light-emitting element so as to be emitted from the emission surface.
[7] The optical module according to [1], further including a reflection surface configured to reflect toward the emission surface light entered from the incidence surface.
[8] A transmission apparatus including: the optical module according to [1]; and an optical transmission member into which light emitted from the optical receptacle enters, in which the following Equation 3 is satisfied:

$$2 X < E 2 < 4 X \qquad ( Equation 3 )$$

where E2 is a diameter on the emission surface of light emitted from the light-emitting element so as to be emitted from the emission surface, and X is a diameter on the end surface of the optical transmission member of light emitted from the light-emitting element.
[9] The transmission apparatus according to [8], in which the following Equation 4 is satisfied:

$$1 < D 1 / D 2 < 2.5 \qquad ( Equation 4 )$$

where D1 is a distance between the center of the light-emitting surface of the light-emitting element and a center of the incidence surface, and D2 is a distance between a center of the emission surface and the end surface of the optical transmission member.

### Advantageous Effects of Invention

According to the present invention, the light coupling efficiency is less reduced even when the positions of an optical receptacle and an optical transmission member are shifted in any direction.

### BRIEF DESCRIPTION OF DRAWINGS

FIG. 1 is a diagram illustrating a configuration of a transmission apparatus of Embodiment 1;

FIGS. 2A to 2C are diagrams illustrating light paths of the transmission apparatus of Embodiment 1;

FIGS. 3A to 3C are diagrams illustrating light paths of the transmission apparatus of a comparative example;

FIGS. 4A to 4C are graphs showing simulation results of Example 1 of No. 1;

FIGS. 5A to 5C are graphs showing simulation results of Comparative Example 1 of No. 9; and

FIG. 6 is a diagram illustrating a configuration of a transmission apparatus of Embodiment 2.

### DESCRIPTION OF EMBODIMENTS

An optical module and a transmission apparatus according to an embodiment of the present invention are elaborated below with reference to the accompanying drawings.

### Embodiment 1

### Configuration of Transmission Apparatus

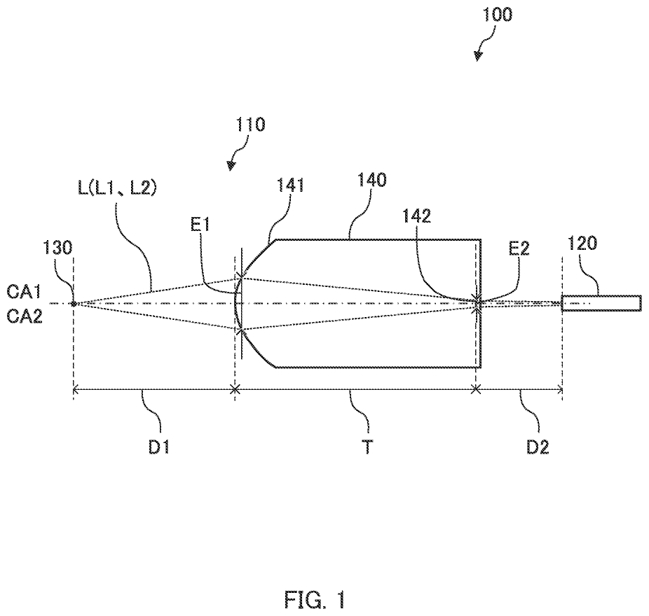

FIG. 1 is a diagram illustrating a configuration of a transmission apparatus.

As illustrated in FIG. 1, transmission apparatus 100 includes optical module 110 and optical transmission member 120. Optical module 110 includes light-emitting element 130 and optical receptacle 140.

Light-emitting element 130 emits light with a predetermined wavelength. Light-emitting element 130 is a vertical-cavity surface-emitting laser (VCSEL). In the present embodiment, light-emitting element 130 is fixed to a substrate not illustrated in the drawings. The number of light-emitting element 130 is not limited. The number of light-emitting element 130 may be one, or two or more. In the present embodiment, one light-emitting element 130 is provided. Note that in the case where a plurality of light-emitting elements 130 is provided, the number of light-emitting elements 130 is the same as the number of incidence surfaces 141, the number of emission surfaces 142, and the number of optical transmission members 120 of optical receptacle 140 described later. In addition, in the following description, light emitted from the center of the light-emitting surface of light-emitting element 130 may be referred to as first light beam L1, and light emitted from an end portion of the light-emitting surface of light-emitting element 130 may be referred to as second light beam L2. In addition, all light beams emitted from the light-emitting surface of light-emitting element 130 may be simply referred to as light L.

Optical receptacle 140 is a resin meniscus lens for optically coupling light-emitting element 130 and the end surface of optical transmission member 120 when optical transmission member 120 is connected. Optical receptacle 140 is disposed between light-emitting element 130 and optical transmission member 120. Optical receptacle 140 is formed of a material that is optically transparent to light with wavelengths used for optical communications. Examples of the material of optical receptacle 140 include transparent resin such as cyclic olefin resin and polyetherimide (PEI) such as ULTEM (registered trademark). In addition, optical receptacle 140 may be manufactured by being integrally molded through injection molding, for example. Optical receptacle 140 includes incidence surface 141 and emission surface 142.

The central axis of incidence surface 141 and the central axis of emission surface 142 may or may not coincide with each other. In the present embodiment, central axis CA1 of incidence surface 141 and central axis CA2 of emission surface 142 coincide with each other. Light path length T between the center of incidence surface 141 and the center of emission surface 142 is preferably within a range from 1.2 cm to 1.8 cm.

Incidence surface 141 is a convex surface for allowing light emitted from light-emitting element 130 to enter optical receptacle 140. Incidence surface 141 refracts at least a part of light L (first light beam L1 and second light beam L2) emitted from light-emitting element 130 such that the light advances toward the optical axis of light-emitting element 130. Incidence surface 141 is disposed to face the light-emitting surface of light-emitting element 130. The number of incidence surfaces 141 is the same as the number of light-emitting elements 130. Specifically, in the present embodiment, one incidence surface 141 is provided.

In the present embodiment, incidence surface 141 has a circular plan shape. Central axis CA1 of incidence surface 141 may be perpendicular to the light-emitting surface of light-emitting element 130, or may not be perpendicular to the light-emitting surface of light-emitting element 130. In the present embodiment, the central axis of incidence surface 141 is perpendicular to the light-emitting surface of light-emitting element 130. In addition, central axis CA1 of incidence surface 141 may coincide with the optical axis of light emitted from light-emitting element 130 (the central axis of the light-emitting surface of light-emitting element 130), or may not coincide with the optical axis of light emitted from light-emitting element 130. Preferably, the light-emitting surface of light-emitting element 130 and the center of incidence surface 141 of optical receptacle 140 overlap each other when optical receptacle 140 is viewed in the direction along the optical axis of light-emitting element 130. In the present embodiment, the central axis of incidence surface 141 coincides with the optical axis of light emitted from light-emitting element 130 (the central axis of the light-emitting surface of light-emitting element 130).

Curvature radius R1 of the center of incidence surface 141 is not limited. Preferably, curvature radius R1 of the center of incidence surface 141 is within a range from 0.278 mm to 0.336 mm. Diameter E1 on incidence surface 141 of light emitted from light-emitting element 130 that impinges on incidence surface 141 is not limited. Preferably, diameter E1 on incidence surface 141 of light emitted from light-emitting element 130 that impinges on incidence surface 141 is within a range from 0.410 mm to 0.520 mm. Here, diameter E1 on incidence surface 141 of light emitted from light-emitting element 130 that impinges on incidence surface 141 means the diameter of the irradiation spot on incidence surface 141 of light L emitted from the light-emitting surface of light-emitting element 130. In addition, the distance D1 between the light-emitting surface of light-emitting element 130 and the center of incidence surface 141 is not limited. Preferably, distance D1 between the light-emitting surface of light-emitting element 130 and the center of incidence surface 141 is within a range from 1.0 mm to 1.2 mm.

Emission surface 142 is a concave surface for emitting, toward the end surface of optical transmission member 120, light that has entered from incidence surface 141 and travelled inside optical receptacle 140. Emission surface 142 focuses a first light flux of first light beam L1 emitted at ±10 degrees with respect to the optical axis on the optical axis of light-emitting element 130 after it is emitted from emission surface 142. In addition, emission surface 142 controls a second light flux of second light beam L2 emitted at ±10 degrees with respect to the optical axis from emission point A, which is an end portion of one light-emitting surface on a plane including the optical axis such that the light is located on the opposite side of emission point A side with respect to the optical axis after it is emitted from emission surface 142. In this manner, emission surface 142 performs collimation of second light beam L2 by focusing first light beam L1 toward focal point P. The “collimation” includes not only making second light beam L2 parallel to the central light beam of light emitted from emission surface 142, but also setting the inclination angle of second light beam L2 with respect to the central light beam of light emitted from emission surface 142 to an angle within ±2 degrees. The inclination angle of second light beam L2 with respect to the central light beam of light emitted from emission surface 142 is an angle with which the change of the light coupling efficiency is within 0.5 dB even when the uniform illuminance of diameter 20 μm is moved by 15 μm in the axis direction of optical transmission member 120. Emission surface 142 is disposed to face the end surface of optical transmission member 120. The number of emission surfaces 142 is the same as the number of incidence surfaces 141. That is, in the present embodiment, one emission surface 142 is provided.

In the present embodiment, emission surface 142 has a circular plan shape. Central axis CA2 of emission surface 142 may be perpendicular to the end surface of optical transmission member 120, or may not be perpendicular to the end surface of optical transmission member 120. In the present embodiment, central axis CA2 of emission surface 142 is perpendicular to the end surface of optical transmission member 120. In addition, in the case where the end surface of optical transmission member 120 is tilted with respect to central axis CA2 of emission surface 142, central axis CA2 of emission surface 142 is tilted with respect to the end surface of optical transmission member 120. In addition, central axis CA2 of emission surface 142 may coincide with the central axis of the end surface of optical transmission member 120 where emitted light impinges, or may not coincide with the central axis of the end surface of optical transmission member 120 where emitted light impinges. In the present embodiment, central axis CA2 of emission surface 142 coincides with the central axis of the end surface of optical transmission member 120 where emitted light impinges.

Curvature radius R2 of the center of emission surface 142 is not limited. Preferably, curvature radius R2 of the center of emission surface 142 is within a range from 0.144 mm to 0.251 mm. Preferably, the distance between the center of emission surface 142 and the center of the end surface of optical transmission member 120 is within a range from 0.4 mm to 0.8 mm.

The type of optical transmission member 120 is not limited. The examples of the type of optical transmission member 120 include optical fibers and light waveguides. In the present embodiment, optical transmission member 120 is an optical fiber. In addition, the optical fiber may be of single mode type or multiple mode type. In the present embodiment, optical transmission member 120 is an optical fiber of single mode type, and includes core 120a and clad 120b. Preferably, the center of the end surface of core 120a is disposed within a virtual column. Preferably, the virtual column is a virtual space with a radius of 3 μm and a length of 30 μm. If the radius of the virtual column is smaller than 3 μm, manufacturing becomes more difficult in terms of assembling errors. If the length of the virtual column is greater than 30 μm, the light coupling efficiency is likely to be deteriorated by a change in refractive index and the like due to temperature change. In addition, more preferably, the virtual column is a virtual space with a radius of 5 μm and a length of 60 μm. In the case where the virtual column is a virtual space with a radius of 5 μm and a length of 60 μm, the coupling efficiency less changes even when assembling errors, refractive index temperature changes, curvature temperature changes, and linear expansions occur in a combined manner. Preferably, the virtual column is disposed such that its central axis is parallel to optical transmission member 120, and that the center of gravity of the virtual column is located on the optical axis at the position where the first light flux is thinnest. Here, in the present embodiment, the virtual column means a region where the light beam density is substantially uniform. Note that in the present embodiment, the end surface of optical transmission member 120 is disposed at the position (focal point) P where the first light flux is thinnest.

In the present embodiment, a part of light L emitted from light-emitting element 130 is controlled to pass through the virtual column. Thus, even when the position of optical transmission member 120 is shifted with respect to second emission surface 142, the reduction in light coupling efficiency can be suppressed.

Transmission apparatus 100 of the present embodiment can further suppress the reduction in light coupling efficiency by further satisfying the following requirements.

Preferably, transmission apparatus 100 satisfies the following Equation 1, where R1 is the curvature radius of the center of incidence surface 141 and R2 is the curvature radius of the center of emission surface 142.

$$R 1 > R 2 \qquad ( Equation 1 )$$

When curvature radius R1 of the center of incidence surface 141 and curvature radius R2 of the center of emission surface 142 satisfy the above-mentioned relationship, the refractive power at emission surface 142 can be increased, and in turn the inclination angle of second light beam L2 with respect to the central light beam of light emitted from emission surface 142 can be controlled to a small angle. In this manner, even in the case where the position of the end surface of optical transmission member 120 is shifted in the Z direction, the reduction in light coupling efficiency can be suppressed.

It is preferable to satisfy the following Equation 2 where E1 is the diameter on incidence surface 141 of light emitted from light-emitting element 130 that impinges on incidence surface 141, and E2 is the diameter on emission surface 142 of the light emitted from light-emitting element 130 so as to be emitted from emission surface 142.

$$E 1 / E 2 > 7 \qquad ( Equation 2 )$$

When diameter E1 on incidence surface 141 of light L emitted from light-emitting element 130 that impinges on incidence surface 141 and diameter E2 on emission surface 142 of light L emitted from light-emitting element 130 so as to be emitted from emission surface 142 satisfy the above-mentioned relationship, the entirety of the second light flux emitted from emission point A at an angle of ±10 degrees with respect to the optical axis can be controlled even when a cover glass is disposed between light-emitting element 130 and incidence surface 141. Further, the curvature radius of emission surface 142 can be reduced.

It is preferable to satisfy the following Equation 3 where E2 is the diameter of light emitted from light-emitting element 130 that is emitted from emission surface 142, and X is the diameter, at the end surface of optical transmission member 120, of light L emitted from light-emitting element 130.

$$2 X < E 2 < 4 X \qquad ( Equation 3 )$$

When diameter E2 of light emitted from light-emitting element 130 that is emitted from emission surface 142, and the diameter X, at the end surface of optical transmission member 120, of light L emitted from light-emitting element 130 satisfy the above-mentioned relationship, the curvature radius of emission surface 142 can be reduced. In addition, the amount of light beams that passes through the virtual column can be increased.

It is preferable to satisfy the following Equation 4 where D1 is the distance between the light-emitting surface of light-emitting element 130 and incidence surface 141, and D2 is the distance between emission surface 142 and the end surface of optical transmission member 120.

$$1 < D 1 / D 2 < 2.5 \qquad ( Equation 4 )$$

When distance D1 between the light-emitting surface of light-emitting element 130 and the center of incidence surface 141 and distance between D2 between the center of emission surface 142 and the end surface of optical transmission member 120 satisfy the above-mentioned relationship, it is possible to suppress the influence of the positional shift of distance D2 between the center of emission surface 142 and the end surface of optical transmission member 120 on the positional shift of distance D1 between the light-emitting surface of light-emitting element 130 and the center of incidence surface 141.

Now the light path of light emitted from light-emitting element 130 in transmission apparatus 100 according to the present embodiment is described. In addition, for comparison, the light path of light emitted from light-emitting element 130 in a transmission apparatus including a known meniscus lens is also described.

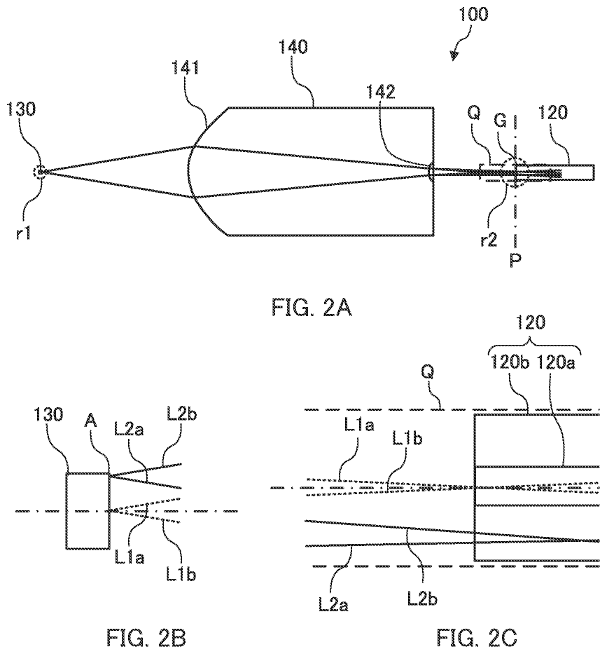

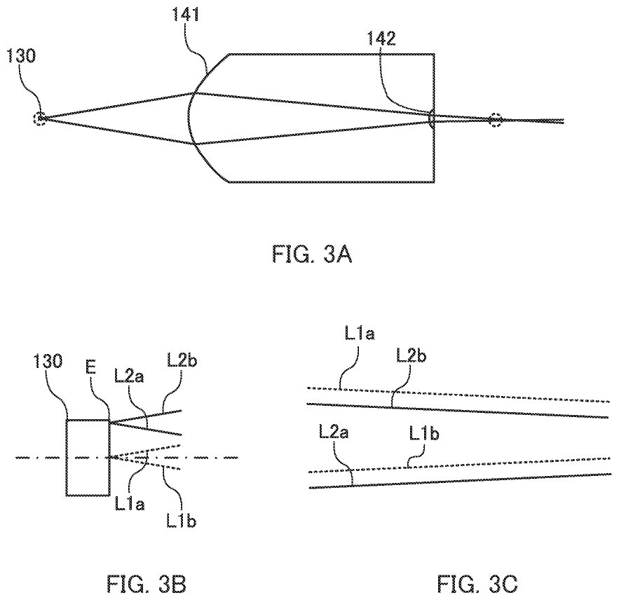

FIG. 2A is a diagram illustrating a light path of transmission apparatus 100 according to the present embodiment, FIG. 2B is an enlarged view of region r1 illustrated in FIG. 2A, and FIG. 2C is an enlarged view of region r2 illustrated in FIG. 2A. FIG. 3A is a diagram illustrating a light path of transmission apparatus 100 according to a comparative example, FIG. 3B is an enlarged view of region r1 illustrated in FIG. 3A, and FIG. 3C is an enlarged view of region r2 illustrated in FIG. 3A. In FIG. 3A, it is assumed that a virtual column with a radius of 5 μm and a length of 60 μm is disposed such that the central axis of the virtual column is parallel to optical transmission member 120 and that the center of gravity of the virtual column is located on the optical axis at the position where the first light flux is thinnest. Here, the drawings illustrate only light beams (the outermost light of the first light flux) L1a and L1b with a largest emission angle in the first light flux of first light beam L1 emitted at ±10 degrees with respect to the optical axis, and light beams (the outermost light of the second light beam) L2a and L2b with a largest emission angle in the second light flux of second light beam L2 emitted at ±10 degrees with respect to the optical axis.

As illustrated in FIGS. 2A to 2C, in transmission apparatus 100 according to the present embodiment, the first light flux emitted from the center of the light-emitting surface of light-emitting element 130 enters from incidence surface 141 and is emitted from emission surface 142. The first light flux emitted from emission surface 142 is focused toward focal point P (the end surface of optical transmission member 120) on the optical axis on the center line of the first light flux.

In addition, as illustrated in FIGS. 2A to 2C, the second light flux emitted from the end portion of the light-emitting surface of light-emitting element 130 enters from incidence surface 141 and is emitted from emission surface 142. The second light flux emitted from emission surface 142 is controlled such that it travels to the opposite side of the emission point side with respect to the optical axis after it is emitted from emission surface 142. In the present embodiment, as illustrated in FIG. 2B, the second light flux emitted from emission point A on the upper side with respect to the optical axis in the drawing is controlled such that the light is located on the opposite side of emission point A side with respect to the optical axis. More specifically, in a plane including the optical axis and emission point A, the second light flux is controlled such that it is located inside the virtual column and on the opposite side of emission point A side with respect to the optical axis after it is emitted from emission surface 142. In this manner, second light beam L2 of light L emitted from light-emitting element 130 is collimated. In addition, since the light beam density inside the virtual column is substantially uniformed, the light coupling efficiency is less reduced even in the case where the positions of emission surface 142 and optical transmission member 120 are shifted. In this case, the spot diameter of second light beam L2 reaching optical transmission member 120 and the spot diameter of light incident on emission surface 142 are substantially the same.

The first light flux and the second light flux emitted from emission surface 142 are separated at focal point P.

### Simulation 1

Changes in light coupling efficiency and shift amounts with changes in parameters in transmission apparatus 100 were simulated. In this case, the direction along the axis of optical transmission member 120 is the Z direction, the direction perpendicular to the Z direction is the X direction, and the direction perpendicular to the Z direction and X direction is the Y direction. For the simulation, nine types of optical receptacles were used. The optical receptacle No. 9 is an optical receptacle of flat convex type. Parameters of the optical receptacles used are shown in Table 1.

TABLE 1

| No. | 1 | 2 | 3 | 4 | 5 |
|---|---|---|---|---|---|
| R1 | 0.319 | 0.319 | 0.336 | 0.285 | 0.344 |
| R2 | 0.190 | 0.212 | 0.187 | 0.132 | 0.150 |
| E1(×2) | 0.480 | 0.420 | 0.502 | 0.430 | 0.520 |
| E2(×2) | 0.056 | 0.060 | 0.050 | 0.054 | 0.058 |
| T | 1.481 | 1.500 | 1.800 | 1.200 | 1.500 |
| D1 | 0.96 | 0.915 | 0.915 | 0.915 | 1.115 |
| D2 | 0.652 | 0.600 | 0.600 | 0.600 | 0.600 |
| R1/R2 | 1.678 | 1.269 | 1.793 | 2.167 | 2.300 |
| R2/R1 | 0.596 | 0.788 | 0.558 | 0.461 | 0.435 |
| E1/E2 | 8.571 | 7.000 | 10.040 | 7.963 | 8.966 |
| T/ | 2.906 | 2.629 | 3.439 | 2.880 | 3.039 |
| (R1 + R2) | | | | | |
| D1D2 | 1.472 | 1.525 | 1.525 | 1.525 | 1.858 |
| D2/D1 | 0.679 | 0.656 | 0.656 | 0.656 | 0.538 |
| X | −0.021 | −0.0409 | −0.020 | −0.011 | −0.036 |
| direction | | | | | |
| (dB) | | | | | |
| Z | 0.444 | 0.426 | 0.417 | 0.443 | 0.441 |
| direction | | | | | |
| (dB) | | | | | |
| X3 μm | −0.00073054 | −0.01545006 | −0.020618648 | −0.00867429 | −0.017540158 |
| (dB) | | | | | |
| Z30 μm | −0.226960994 | −0.205913153 | 0.21560062 | 0.22579463 | −0.216725344 |
| (dB) | | | | | |

| No. | 6 | 7 | 8 | 9 |
|---|---|---|---|---|
| R1 | 0.278 | 0.319 | 0.308 | 0.356 |
| R2 | 0.272 | 0.183 | 0.123 | ∞ |
| E1(×2) | 0.410 | 0.460 | 0.506 | 0.260 |
| E2(×2) | 0.056 | 0.062 | 0.040 | 0.108 |
| T | 1.500 | 1.500 | 1.500 | 1.500 |
| D1 | 0.715 | 0.915 | 0.915 | 0.96 |
| D2 | 0.600 | 0.800 | 0.500 | 0.571 |
| R1/R2 | 1.023 | 1.744 | 2.498 | 0.000 |
| R2/R1 | 0.978 | 0.573 | 0.400 | ∞ |
| E1/E2 | 7.321 | 7.419 | 12.650 | 2.407 |
| T/ | 2.728 | 2.987 | 3.481 | 0.000 |
| (R1 + R2) | | | | |
| D1D2 | 1.192 | 1.144 | 1.830 | 1.681 |
| D2/D1 | 0.839 | 0.874 | 0.5460 | 0.595 |
| X | −0.010 | −0.055 | −0.029 | −2.999 |
| direction | | | | |
| (dB) | | | | |
| Z | 0.352 | 0.307 | 0.492 | 0.199 |
| direction | | | | |
| (dB) | | | | |
| X3 μm | 0.005442267 | −0.036895529 | −0.023447301 | −1.207110156 |
| (dB) | | | | |
| Z30 μm | 0.166055424 | 0.157993792 | −0.240502143 | −0.172907248 |
| (dB) | | | | |

This simulation examined whether the change in light coupling efficiency is within 0.5 dB even when the end surface of optical transmission member 120 is shifted in the X direction, Y direction and Z direction with respect to the optical receptacle. The shift amount in the X direction was ±5 μm, and the shift amount in the Z direction was ±30 μm.

With the optical receptacles Nos. 1 to 8 of Examples 1 to 8 shown in Table 1, even when the position of the end surface of optical transmission member 120 was shifted by ±5 μm in the X direction or by ±30 μm in the Z direction, the change in light coupling efficiency was within 0.5 dB. Although not shown in the drawing, the optical receptacles Nos. 1 to 7 of Examples 1 to 8 control the light such that the first light flux of first light beam L1 emitted at ±10 degrees with respect to the optical axis is focused on the central light beam of the first light flux after it is emitted from emission surface 142, and that the second light flux of second light beam L2 emitted at ±10 degrees with respect to the optical axis from the emission point that is an end portion of one light-emitting surface on the plane including the optical axis is located on the opposite side of the emission point side with respect to the central light beam of the first light flux after it is emitted from emission surface 142.

On the other hand, with the optical receptacle No. 9 of Comparative Example 1, the change in light coupling efficiency was smaller than 0.5 dB when the position of the end surface of optical transmission member 120 was shifted by ±30 μm in the Z direction, but the change in light coupling efficiency was far greater than 0.5 dB when the position of the end surface of optical transmission member 120 was shifted by ±5 μm in the X direction.

### Simulation 2

Simulations were performed for each of the optical receptacle No. 1 of Example 1 and the optical receptacle No. 9 of the comparative example by shifting the position of the light-emitting element in the Y direction, shifting the position of the end surface of optical transmission member in the Z direction, and changing the refractive index of the optical receptacle.

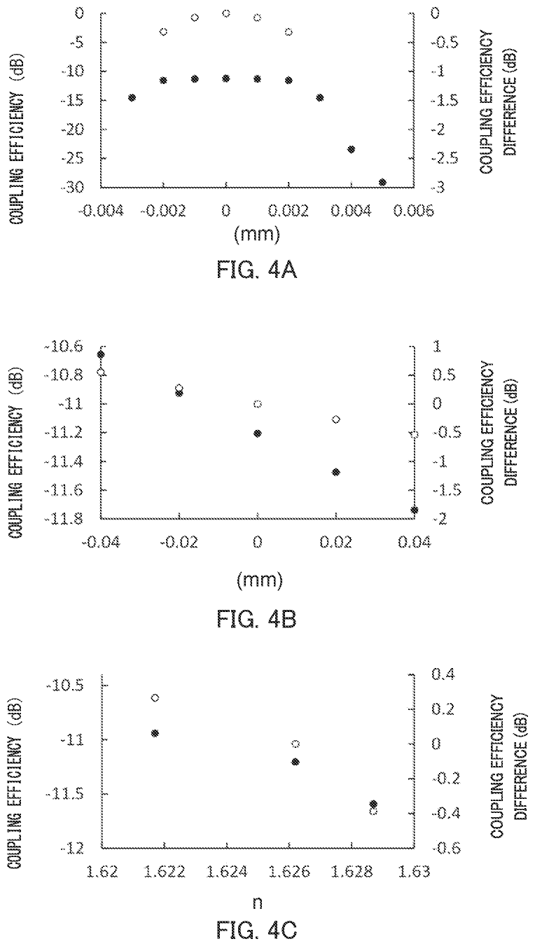

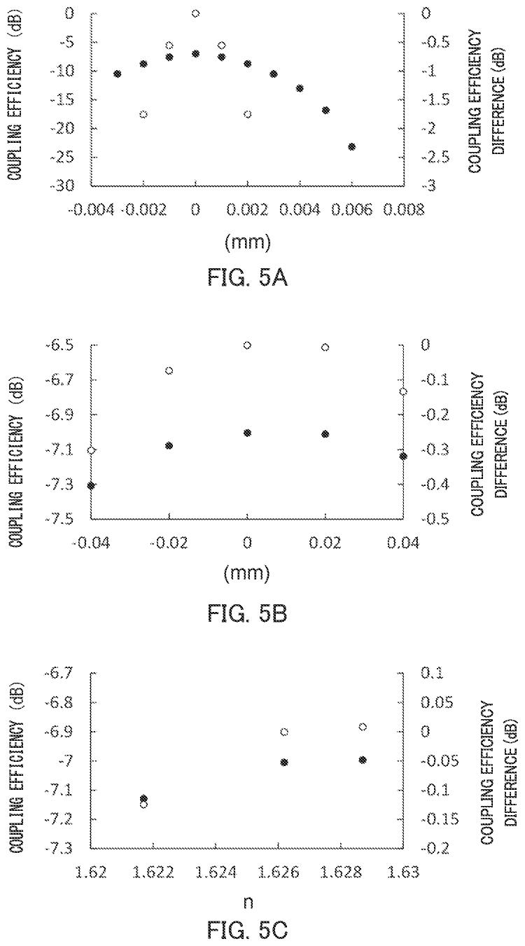

FIGS. 4A to 4C are graphs showing results of the optical receptacle No. 1 of Example 1, and FIGS. 5A to 5C are graphs showing results of the optical receptacle No. 9 of Comparative Example 1. FIG. 4A is a graph showing results obtained by shifting the position of the light-emitting element in the Y direction, FIG. 4B is a graph showing results obtained by shifting the position of the end surface of optical transmission member in the Z direction, and FIG. 4C is a graph showing results obtained by changing the refractive index of the optical receptacle. FIG. 5A is a graph showing results obtained by shifting the position of the light-emitting element in the Y direction, FIG. 5B is a graph showing results obtained by shifting the position of the end surface of optical transmission member in the Z direction, and FIG. 5C is a graph showing results obtained by changing the refractive index of the optical receptacle. In FIGS. 4A to 5C, the black circle represents the coupling efficiency (the first axis on the left side), and the white circle represents the coupling efficiency difference (the first axis on the right side).

FIG. 4A illustrates the coupling efficiency and the coupling efficiency difference plotted on the coordinates for the shift of the light-emitting element when the optical receptacle No. 1 of Example 1 is used. Note that the coupling efficiency means the light coupling efficiency between the light-emitting element and the optical transmission member. In addition, the coupling efficiency difference means the difference from the coupling efficiency of the case where the shift of the light-emitting element is 0 mm. That is, the coupling efficiency difference is synonymous with the change in light coupling efficiency in Simulation 1.

FIG. 4B illustrates the coupling efficiency and the coupling efficiency difference plotted on the coordinates for the shift of the optical transmission member when the optical receptacle No. 1 of Example 1 is used. FIG. 4C illustrates the coupling efficiency and the coupling efficiency difference plotted on the coordinates for the refractive index difference when the optical receptacle No. 1 of Example 1 is used. FIG. 5A illustrates the coupling efficiency and the coupling efficiency difference plotted on the coordinates for the shift of the light-emitting element when the optical receptacle No. 9 of Comparative Example 1 is used. FIG. 5B illustrates the coupling efficiency and the coupling efficiency difference plotted on the coordinates for the shift of the optical transmission member when the optical receptacle No. 9 of Comparative Example 1 is used. FIG. 5C illustrates the coupling efficiency and the coupling efficiency difference plotted on the coordinates for the refractive index difference when the optical receptacle No. 9 of Comparative Example 1 is used.

As illustrated in FIGS. 4A and 5A, the light coupling efficiency is less reduced even with a shift of the position of the light-emitting element side when the optical receptacle of Example 1 is used in comparison with the case where the optical receptacle of Comparative Example 1 is used.

As illustrated in FIGS. 4B, 4C, 5B and 5C, it is possible to maintain the coupling efficiency and suppress the reduction in coupling efficiency with the refractive index change even with a shift of the optical transmission member in the Z direction when the optical receptacle of Example 1 is used in comparison with the case where the optical receptacle of Comparative Example 1 is used.

### Effects

As described above, since transmission apparatus 100 of the present embodiment is controlled such that the first light flux is focused toward the focal point on the optical axis and that the second light flux travels toward the opposite side of the emission point that is the end portion of the light-emitting surface with respect to the optical axis, and thus, the light coupling efficiency is less reduced even when the positions of the optical receptacle and the optical transmission member are shifted in any direction.

### Embodiment 2

### Configuration of Transmission Apparatus

Next, transmission apparatus 200 of Embodiment 2 is described. Transmission apparatus 200 of the present embodiment is different from transmission apparatus 100 of Embodiment 1 only in the configuration of optical receptacle 140. In view of this, optical receptacle 140 is mainly described below, and the same configurations are denoted with the same reference numerals and the description thereof is omitted.

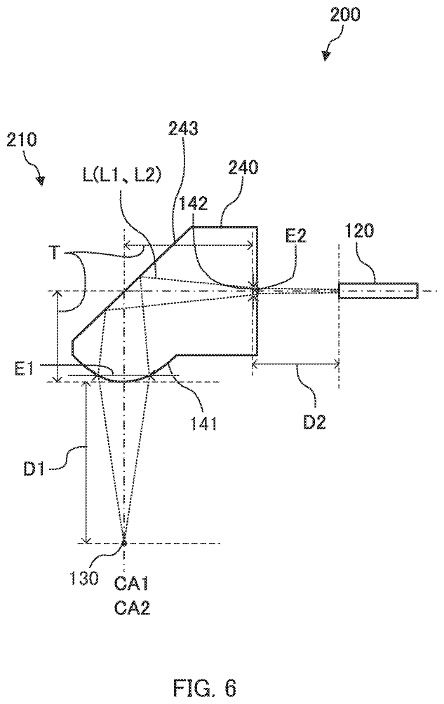

FIG. 6 is a diagram illustrating a configuration of transmission apparatus 200 of Embodiment 2.

As illustrated in FIG. 6, transmission apparatus 200 of the present embodiment includes optical module 210 and optical transmission member 120. Optical module 210 includes light-emitting element 130 and optical receptacle 240.

Optical receptacle 240 includes incidence surface 141, emission surface 142, and reflection surface 243.

Reflection surface 243 reflects toward emission surface 142 light entered from incidence surface 141. In the present embodiment, reflection surface 243 may be a flat surface or a convex surface. In the present embodiment, reflection surface 243 is a flat surface.

Also in the present embodiment, the light emitted from light-emitting element 130 toward the end surface of optical transmission member 120 includes first light beam L1 emitted from the center of the light-emitting surface of light-emitting element 130, and second light beam L2 emitted from the end portion of light-emitting surface. In addition, the first light flux of first light beam L1 emitted at ±10 degrees with respect to the optical axis is focused on the central light beam of the first light flux after it is emitted from emission surface 142. Further, the second light flux of second light beam L2 emitted at ±10 degrees with respect to the optical axis from emission point A, which is an end portion of one light-emitting surface on the plane including the optical axis is controlled to be located on the opposite side of emission point A side with respect to the central light beam of the first light flux after it is emitted from emission surface 142.

### INDUSTRIAL APPLICABILITY

The optical module according to the present invention is suitable for optical communications using optical transmission members, for example.

### REFERENCE SIGNS LIST

100, 200 Transmission apparatus
110, 210 Optical module
120 Optical transmission member
130 Light-emitting element
140, 240 Optical receptacle
141 Incidence surface
142 Emission surface
243 Reflection surface

1. An optical module comprising:
a light-emitting element disposed on a substrate; and
an optical receptacle configured to optically couple the light-emitting element and an end surface of an optical transmission member when the optical transmission member is connected,
wherein the optical receptacle includes:
an incidence surface that is a convex surface configured to allow incidence of light emitted from the light-emitting element, and
an emission surface that is a concave surface configured to emit to the end surface of the optical transmission member light entered from the incidence surface,
wherein light emitted from the light-emitting element toward the end surface of the optical transmission member includes a first light beam emitted from a center of a light-emitting surface of the light-emitting element, and a second light beam emitted from an outer edge of the light-emitting surface,
wherein a first light flux of the first light beam is focused on a light path of a central light beam of the first light flux after the first light flux is emitted from the emission surface, the first light flux being a light flux that is emitted at +10 degrees with respect to an optical axis, and
wherein in a plane that includes a light path of the central light beam of the first light flux and is perpendicular to the substrate, a second light flux of the second light beam is controlled to be located on an opposite side of a side on which the emission point is located with respect to the light path of the central light beam of the first light flux after the second light flux is emitted from the emission surface, the second light flux being a light flux that is emitted at ±10 degrees with respect to the optical axis from one of two emission points that are the outer edge of the light-emitting surface on the plane.

2. The optical module according to claim 1, wherein when a virtual column with a radius of 3 μm and a length of 30 μm is disposed such that a central axis of the virtual column is parallel to the optical transmission member and that a center of gravity of the virtual column is located on the light path of the central light beam of the first light flux at a position where the first light flux is thinnest,
in a plane including the light path of the central light beam of the first light flux and the emission point, the second light flux is controlled to be located inside the virtual column and on the opposite side of the side on which the emission point is located with respect to the light path of the central light beam of the first light flux after the second light flux is emitted from the emission surface.

3. The optical module according to claim 2, wherein a center of an end surface of a core of the optical transmission member is disposed inside the virtual column.

4. The optical module according to claim 1, wherein the position where the first light flux is thinnest and a position where the second light flux is thinnest are different from each other.

5. The optical module according to claim 1, wherein the following Equation 1 is satisfied:
$$R 1 > R 2 \qquad ( Equation 1 )$$
where R1 is a curvature radius of a center of the incidence surface, and R2 is a curvature radius of a center of the emission surface.

6. The optical module according to claim 1, wherein the following Equation 2 is satisfied:
$$E 1 / E 2 > 7 \qquad ( Equation 2 )$$
where E1 is a diameter on the incidence surface of light emitted from the light-emitting element that impinges on the incidence surface, and E2 is a diameter on the emission surface of light emitted from the light-emitting element so as to be emitted from the emission surface.

7. The optical module according to claim 1, further comprising a reflection surface configured to reflect toward the emission surface light entered from the incidence surface.

8. A transmission apparatus comprising:
the optical module according to claim 1; and
an optical transmission member into which light emitted from the optical receptacle enters,
wherein the following Equation 3 is satisfied:
$$2 X < E 2 < 4 X \qquad ( Equation 3 )$$
where E2 is a diameter on the emission surface of light emitted from the light-emitting element so as to be emitted from the emission surface, and X is a diameter on the end surface of the optical transmission member of light emitted from the light-emitting element.

9. The transmission apparatus according to claim 8, wherein the following Equation 4 is satisfied:
$$1 < D 1 / D 2 < 2.5 \qquad ( Equation 4 )$$
where D1 is a distance between the center of the light-emitting surface of the light-emitting element and a center of the incidence surface, and D2 is a distance between a center of the emission surface and the end surface of the optical transmission member.
